(19) United States
(12) Patent Application Publication
(10) Pub. No.: US 2008/0318056 A1
(43) Pub. Date: Dec. 25, 2008

(54) Method for Making a Composite Product, and a Composite Product

(75) Inventor: Markku Vilkki, Lahti (FI)

Correspondence Address: YOUNG & THOMPSON, 209 Madison Street, Suite 500, ALEXANDRIA, VA, 22314, US

(73) Assignees: Conenor OY, Tampere (FI); Maillefer Extrusion OY, Vantaa (FI)

(21) Appl. No.: 12/097,573

(22) PCT Filed: Jun. 2, 2006
(86) PCT No.: PCT/FI06/50233

§ 371 Date: Jun. 16, 2008

(30) Foreign Application Priority Data
Dec. 14, 2005 (FI) 2005673

(51) Int. Cl. B32B 7/04

(52) U.S. Cl. 428/420; 264/211.22; 425/404

(57) ABSTRACT

Fibre material and at least one plastic material is extruded in such a way that a composite product (11) is produced. To increase the strength of the product (11) and to improve its heat resistance, the at least one plastic material of the product (11) is cross-linked in such a way that at least a surface of the wall of the product (11) is provided with a cross-linking degree higher than the cross-linking degree of an inner part of the wall of the product (11).

### BACKGROUND OF THE INVENTION

The invention relates to a method for making a composite product, the method comprising extruding a mixture of material with an extruder, the mixture containing fibre material and at least one plastic material.

The invention further relates to a composite product consisting of fibre material and at least one plastic material.

The invention still further relates to an extruder including a nozzle, means for feeding material through the nozzle, heating means for heating the material, cooling means arranged in connection with the nozzle to cool the material flowing through the nozzle so that a cooling zone is created in the nozzle, and a mandrel arranged inside the nozzle.

In the extrusion of a composite product containing fibre material and plastic, the aim is to remove moisture from the fibre material as carefully as possible. Moisture may be removed in advance by drying the fibre material before it is fed into the extruder. Prior art also knows solutions in which the extruder is provided with moisture removal apertures for removing the moisture from the fibre material. The reason for removing the moisture is that even the slightest moisture remaining in the material tends to cause what is known as bubbling and break the surfaces of the manufactured product immediately after it comes out of the nozzle. To prevent this, when nozzle cooling calibration is used, the nozzle has to be cooled so cold that the counter pressure thereby created reduces yield significantly and impairs process manageability. With negative pressure calibration, on the other hand, significant internal tensions are created in the product in the cooling water basin, which considerably reduce the impact strength of the composite product.

A further problem is that the mass to be extruded does not have a sufficient melt viscosity to keep the piece together when it is warm if the proportion of plastic is in the order of 30% by weight or more and the plastic has a low viscosity, i.e. the melt index of the plastic is high. The use of plastic of a high melt index is desirable, because the plastic mixes extremely well with fibre inside the extruder, before entering the nozzle. Another problem is that when the nozzle is cooled by decreasing the temperature of its surface, a layer of material may freeze onto the surfaces of the nozzle while material underneath still continues to flow out of the nozzle. This means that the device does not produce a solid product.

In broad products problems may arise from non-uniform mass flow in the nozzle. The reason for this is that materials may contain hotter and colder streams due to temperature gradients created by the extruder and the nozzle, or the material may be non-homogenous. The temperature behaviour of the melt viscosity of the plastic causes the hotter zone to flow more rapidly than the colder one, the cooling nozzle surface further worsening the situation because the cooler flow area cools more and faster.

A composite product may also contain coupling agents, such as maleated anhydride acids grafted onto plastic. The aim of using coupling agents is to improve the bond between the fibre and the plastic and to prevent moisture from being absorbed in a composite product. Coupling agents are, however, relatively expensive and therefore their impact on the material expenditure of the end product easily becomes quite important.

### BRIEF DISCLOSURE OF THE INVENTION

It is an object of the invention to provide a novel method for manufacturing a composite product and composite product.

The method of the invention is characterized by comprising cross-linking the at least one plastic material in such a way that at least a surface of the wall of the product has a cross-linking degree that is higher than the cross-linking degree of an inner part of the wall of the product.

Further, the product of the invention is characterized in that the plastic material of the product is cross-linked in such a way that at least a surface of the wall of the product has a cross-linking degree that is higher than the cross-linking degree of an inner part of the wall of the product.

Finally, the extruder of the invention is characterized in that the mandrel is arranged to become smaller towards its distal end so that an expansion space is provided in the nozzle, the expansion space being arranged to start at the cooling zone or thereafter.

An idea of the invention is to extrude fibre material and at least one plastic matter to produce a composite product. The at least one plastic material of the product is cross-linked in such a way that at least one surface of the product wall has a cross-linking degree that is higher than the cross-linking degree of an inner part of the product wall. This increases the strength of the product and improves its heat resistance. Nevertheless, the size of the cross-linking apparatus and the time used for the cross-linking will be reasonable, because the product is not cross-linked entirely. If desired, the outer surface of the product may be cross-linked and its inner surface left without cross-linking, whereby the moisture in the fibre material is released the product through the inner surface. Cross-linking of the product surfaces enables the product to be provided with a sufficiently rigid surface coat so that vapour pressure caused by moisture inside the product is not sufficient to cause bubbles on the surface of the product. The product can thus be kept together, calibrated and cooled exactly to the desired measure, even if some moisture were left in the material. Due to the cross-linking of the surfaces the material slides better in the nozzle. This reduces nozzle pressure and enables high extruder yield to be maintained. If the material to be cross-linked contains peroxide, i.e. the product is cross-linked by means of heat, the melt viscosity of the material to be extruded increases as temperature rises. This in turn provides an opportunity to apply a higher nozzle temperature, which further reduces nozzle pressure. The properties of the composite product regarding use outdoors, such as its strength, dimensional stability and tendency to decay mainly depend on how much moisture the product absorbs. The disclosed solution enables the product surface to be provided with a moisture barrier for preventing or at least slowing down the degrading effects of moisture on the product. As regards impact strength, the surfaces of the product play an essentially role in cracking caused by a blow. The disclosed solution enables the product surfaces to be made to sustain blows better and, as a result, the product as a whole will also sustain blows extremely well even if a weaker material were used underneath the surface layer. By means of the disclosed solution it is possible to avoid the need to add coupling agents into the material, which keeps the material costs at a reasonably low level and yet the process is extremely well manageable and high extruder gain is obtained. Cross-linking allows the amount of creep, i.e. deflection under load, to be reduced in the manufactured product. Consequently, the disclosed solution enables low-density polyethylene LDPE, for example, to be used for manufacturing a product. Low-density polyethylene LDPE is available at a relatively affordable cost from recycling, for example, because it is otherwise quite difficult to recycle. Moreover, low-density polyethylene LDPE has a high melt index, which is useful in extrusion because the material mixes extremely well with fibre. Furthermore, the disclosed solution allows paper or board coated with low-density polyethylene LDPE or other plastic generally available from recycling at a low cost and, such as liquid packaging materials, other industrial packaging materials, such as craft paper and fibre-based bags, the thorough drying of which is extremely laborious and expensive, to be used as raw material.

### BRIEF DESCRIPTION OF THE FIGURES

The invention will be described in greater detail with reference to the accompanying drawings, in which

FIG. 1 is a schematic, sectional side view of an extruder;

FIG. 2 is a schematic, sectional side view of a second extruder;

FIG. 3 is a schematic, sectional side view of a wall of an extruded product;

FIG. 4 is a schematic, sectional side view of a wall of a second extruded product;

FIG. 5 is a schematic, sectional side view of a nozzle;

FIG. 6 is a schematic sectional end view of a product manufactured with the apparatus of FIG. 5;

FIG. 7 a schematic sectional view of a second nozzle seen diagonally from the above; and

FIG. 8 is a schematic sectional end view of a product manufactured with the apparatus of FIG. 7.

For the sake of clarity some embodiments of the invention shown in the Figures are simplified. In the Figures, like parts are indicated with like reference numerals.

### DETAILED DISCLOSURE OF SOME EMBODIMENTS OF THE INVENTION

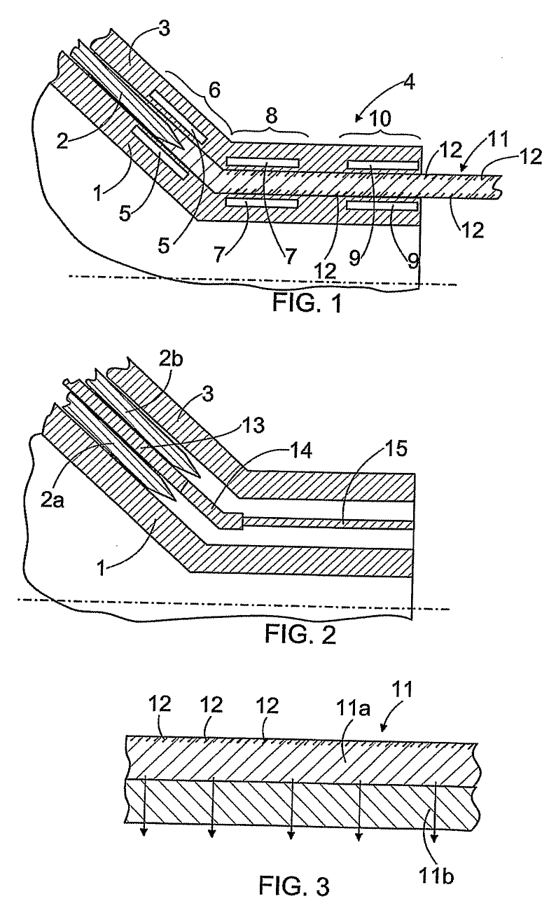

FIG. 1 shows a part of an extruder at the vicinity of its nozzle. The extruder comprises an inner stator 1 and a tapering conical rotor 2 arranged outside the inner stator. Outside the rotor 3 there is provided a tapering conical outer stator 3. Between the rotor 2 and the stators 1 and 3 there is a feed gap, in which the material to be extruded flows when the rotor 2 is rotated.

For the sake of clarity, FIG. 1 does not show the devices for rotating the rotor 2 or the material feed devices for feeding the material to be extruded to the inside and the outside of the rotor 2. Further, also for the sake of clarity, FIG. 1 does not show the grooves provided in the stators 1 and 3 and/or the rotor 2 for conveying the material out of the apparatus.

By rotating the rotor 2 the material is supplied through the feed gaps to the nozzle 4.

The extruder is provided with heating means 5 arranged at the distal end of the rotor 2 in the stators 1 and 2. The heating means 5 may be electrical resistors, for example. The heating means form a first heating zone 6 of the extruder.

The nozzle 4 is provided with second heating means 7. The second heating means may also be electrical resistors, for example. The second heating means 7 form a second heating zone 8. Further, the nozzle 4 is provided with cooling means 9 arranged after the second heating means 7. The cooling means 9 may be pipes or channels, for example, in which cooling agent, such as water, circulates. The cooling means 9 provide the extruder nozzle 4 with a cooling zone 10.

When cross-linking material, such as polyolefin, for example polyethylene PE, is being extruded, peroxide may be added into the material. When this material mixture is then heated to a temperature above the cross-linking temperature, the peroxide starts to react, thereby cross-linking the material. The cross-linking depends on temperature and time.

In the conical extruder of FIG. 1 the travel time of material is typically relatively short, less than 30 seconds, for example. This means that the first heating zone 6 may be arranged in the extruder, i.e. cross-linking can be started when the material is still in the feed gap between the extruder rotor and stator. The material is further heated in the second heating zone in the nozzle 4. Moreover, the surfaces of the material are heated by friction caused by the surfaces of the extruder and its nozzle 4. Consequently, the temperature of the material surfaces in particular rises to so that the cross-linking reaction begins. Therefore when the material arrives at the cooling zone 10, its surfaces are cross-linked. Cross-linking of the surfaces reduces friction between the outer surface of the material and the inner surface of the nozzle, thus allowing the material to flow relatively fluently through the cooling zone. Since the cross-linking of the surfaces reduces friction, the process is self-regulated as regards generation of friction heat and thereby a material having a uniform cross-linking quality is obtained. Uniform quality is further enhanced because a material that contains peroxide, i.e. one in which cross-linking takes place due to heat, has a melt viscosity that increases as temperature rises and therefore a desired stabile flow state approaching what is known as a plug flow is easier to achieve.

In the cooling zone 10 the nozzle 4 and thereby the plastic material are cooled intensively. This means that the plastic in the material to be extruded is cooled so that it crystallizes. As a result, the product 11 obtained by the disclosed solution has an excellent strength and the product 1 is excellent also as to its heat resistance properties.

In other words, the disclosed solution provides a cross-linking in a product in such a way that the cross-linking degree in a wall surface of the product is higher than the cross-linking degree in an inner part of the product wall. In FIG. 1 lines 12 depict the cross-linking degree, i.e. they illustrate that the cross-linking degree in the wall surface of the product 11 is higher than the cross-linking degree in the inner part of the product wall.

To prevent the material from sticking, slip agents may be added to the mixture to be extruded. In addition, the surfaces of the nozzle 4 may be coated with polytetrafluoroethylene PTFE, for example.

Having left the extruder the product 11 may be cooled in a post-cooling basin, for example, or it may be treated in other ways known per se. The product 11 may be a pipe, decoration moulding, board, plank, plate, or some other piece or a similar product. The structure and outer appearance of the product are defined by the structure of the nozzle 4.

To activate the cross-linking reaction the temperature of the material to be extruded is brought to a sufficiently high level. A suitable temperature level can be determined by experimenting and it mainly depends on the properties of the peroxide to be used. Peroxides are available in different grades depending on the temperature in which their disintegration, i.e. the cross-linking effect on plastic, begins and on how rapidly each grade is disintegrated. A suitable grade is usually chosen according to the temperature in which the material to be extruded is to be processed on the basis of the plastic used therein. If a low-density polyethylene LPDE is used, it is typically extruded from the extruder at a temperature of about 130° C., in which case the temperature of the surface of the composite mass containing fibre may be about 140° C., depending on the friction between the mass and the nozzle. In this case the cross-linking nozzle is heated to a temperature in the order of 150-160° C. and a peroxide quality is chosen in which cross-linking starts at a temperature of about 140° C. and whose half life at 160° C. is very short, i.e. in the order of some seconds or less. The peroxide can be dosed into the material in a powder form or in granules when preparing the mixture. It is also possible to pump the peroxide in a liquid form directly into the extruder with a precision pump.

The material used for forming the product 11 is a composite material containing plastic and fibre material. The plastic may be polyolefin, for example, such as polyethylene PE. The proportion of plastic in the material may be 10 to 30% by weight, for example. The proportion of fibre, such as sawdust or some other suitable wood material, in the material may be 50 to 85% by weight, for example. The amount of peroxide that can be mixed into this material is about 0.1% by weight of the proportion of plastic. As stated, the fibre may consist of wood, such as sawdust, woodchips, or some other by-product of mechanical wood processing industry. Further, the fibre material may consist of for example flax, sisal, hemp, kenaf, jute, rice husk, straw, for example from rice, maize, wheat or other cereal, or similar natural fibre materials. Moreover, the fibre material may consist of paper, cardboard, or the like, coated with plastic, such as liquid packaging materials, other industrial packaging materials, and the fibre waste produced during their manufacture.

Typically the most widely available recycled plastic is low-density polyethylene LDPE that has a low elasticity modulus and therefore it is relatively difficult to use for producing rigid recycled products. However, low-density polyethylene LDPE suits well the disclosed solution because it has a high melt viscosity and therefore it mixes well with the fibre material. Further, since in the solution disclosed here the plastic material is cross-linked, it is possible to significantly reduce the creep of the product, i.e. its bending under load. The result is therefore an excellent product suitable for demanding applications. In addition, compared with other cross-linking methods, the adding of peroxide into the process is an inexpensive and simple way to cross-link polyethylene waste.

FIG. 2 shows a part of an extruder that has a conical inner rotor 2a outside an inner stator 1. Outside the inner rotor 2a there is an intermediate stator 13 and outside the intermediate stator 13 a tapering conical outer rotor 2b. Between each rotor 2a and 2b and stator 1, 13 and 3 there is provided a feed gap in which the material to be extruded flows when the rotors 2a and 2b are rotated.

The end of the intermediate stator 13 is provided with a head piece 14 immovably attached thereto. The head piece 14 comprises rods 15 extending into the nozzle 4. The material is extruded around the rods 15. The apparatus of FIG. 2 is used for producing pipes having holes in its walls. The surface of the rods 15 produces friction, which in turn creates heat that cross-links the inner surface of the holes. Cross-linking of the surfaces of the holes increases the strength of the product.

The rods 15 may be hollow and connected to a conduit traversing the head piece 14 and the intermediate stator 13, thereby allowing warm air, for example, to be supplied through them. This allows the material to be heated from inside the holes, which further enhances the cross-linking of the holes. Also the surfaces of the rods 15 may be coated with polytetrafluoroethylene PTFE.

FIG. 3 shows a wall of a double layer product 11, such as a pipe, having an outer layer 11a and an inner layer 11b. This kind of product may be formed with the extruder of FIG. 2, for example, provided with two rotors. If there are no rods 15 in the extruder, there will be no holes inside the product.

The product becomes more rigid when the amount of the fibre material in proportion to that of the plastic is increased in the mixture. On the other hand, increasing the amount of plastic improves moisture insulation capability. Consequently, a particularly good combined effect is obtained by a high content of fibre material in the inner layer and a high plastic content in the outer layer of the product. From the point of view of manufacturing technique, it is in this case preferable that the plastic material of the inner layer is a mixture of plastic fibre material that is extrudable at a higher temperature and contains no peroxide. The heat in this inner layer material cross-links in a controlled manner, starting from the inside, the cooler mixture of plastic fibre material containing peroxide and extruded thereon as the outer layer. In addition, the material of the outer layer may be further cross-linked by using an extruder heated from the outside or some other external method.

The outer layer 11a may be formed as a mixture of polyethylene PE and fibre material, for example. On the outer surface of the outer layer 11a the polyethylene is cross-linked. The inner layer 11b may be made of a mixture of polyvinyl acetate PVA and fibre material. The amount of polyvinyl acetate PVA may be 1 to 25% by weight, for example. Polyvinyl acetate is an excellent adhesive for wood-plastic composite and allows the material to be forced out of the extruder 4 when it is hot. The polyethylene in the outer layer 11a may be cross-linked from the inside by utilizing the heat in the polyvinyl acetate mass and from the outside by means of heating members provided in the extruder and in the nozzle. Since polyvinyl acetate PVA is water-soluble, residual moisture possibly left in the material is able to exit through the inner layer 11b as shown by arrows in FIG. 3. As a result, a product of a uniform quality and not containing bubbles is obtained.

The temperature window of polyvinyl acetate PVA is relatively limited. A combination fairly easy to control is one in which the inner layer 11b is made of a plastic fibre mixture containing a polypropene copolymer or high-density polyethylene HDPE and the outer layer 11a is made of a material containing low-density polyethylene LDPE. The materials of the outer layer 11a and the inner layer 11b must be capable of attaching/welding together, at least weakly, to ensure that the product does not fall into parts because the layers become detached from one another.

It is also possible to form the product 11 so that the plastic material in the inner layer 11b is partly cross-linked and the outer layer 11a is not cross-linked.

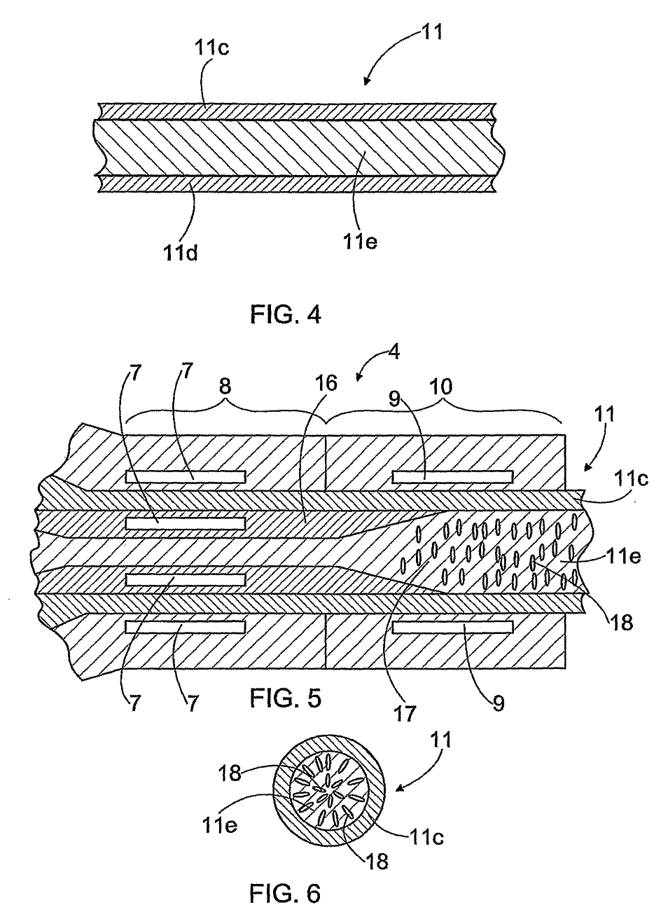

FIG. 4 shows a wall of a tubular product 11 having an outer surface layer 11c and an inner surface layer 11d formed of a solid mixture of fibre and plastic, the plastic portion being at least partly cross-linked. The intermediate layer 11e, in turn, is made of a lighter foamed mixture of fibre and plastic. Consequently, the average specific weight of the materials in the surface layers 11c and 11d is higher than the average specific weight of the material forming the intermediate layer 11e left inside the surface layers 11c and 11d.

FIG. 5 shows a nozzle 4 provided with a mandrel 16 therein. The mandrel 16 is centrally positioned in the nozzle 4 by means of spider legs so that the material forming the surface layer 11c flows outside the mandrel 16. Further, the mandrel 16 is provided with a central conduit through which the material forming the intermediate layer 11e flows. The conduit in the mandrel 16 expands towards its distal end, thereby forming an expansion space 17 in the nozzle 4. The nozzle 4 is shaped so that the expansion space 17 does not start before the cooling zone 10. The border line between the heating zone 8 and the cooling zone 10 sets to a point where the temperature of the surface of the nozzle 4 changes from a temperature warmer than the temperature of the material flowing therein to a temperature colder than that.

In other words, the surface layer 11c is cooled such that the surface layer 11c becomes cured and cross-linked when the material of the intermediate layer 11e is foamed in the expansion space 17. The material in the intermediate layer 11e may be foamed by means of a chemical foaming agent, for example.

The cured and cross-linked surface layer 11c is not capable of yielding during the foaming. Therefore the only direction for the material of the intermediated layer 11c to expand is in the direction of thickness, i.e. in a transverse direction with respect to the direction of movement.

FIG. 6 shows a product 11 made with the apparatus of FIG. 5. The product in FIG. 6 is a round rod, but depending on the shape of the nozzle 4, the product may be oval, angular or have some other shape.

Since the material is only allowed to expand in transverse direction, needle-like bubbles 18 that set in a radial manner are formed therein.

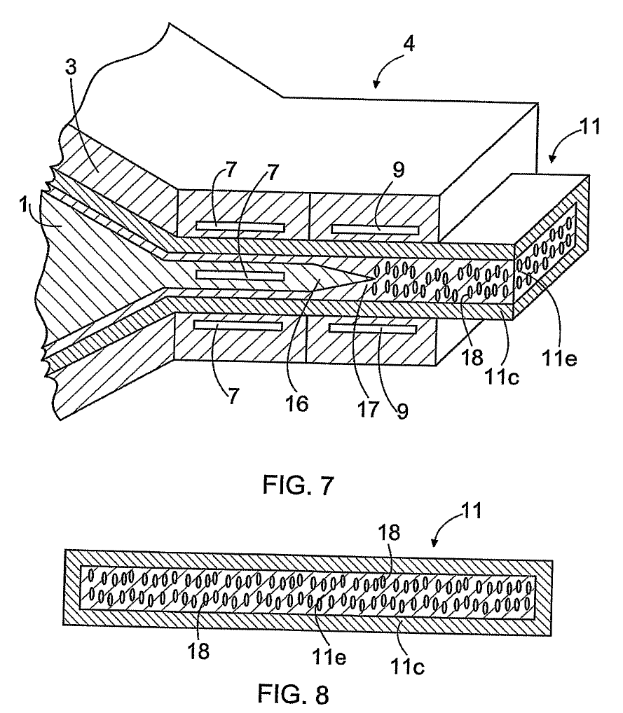

FIG. 7 shows a nozzle 4 having a shape applicable for producing a planar product 11. In the nozzle 4 of FIG. 7 the mandrel 16 is fastened to the distal end of the inner stator 1. Therefore the mandrel 16 does not require spider legs that would cause a weld line in the product.

In the solution of FIG. 7 also the material forming the intermediate layer 11e is arranged to flow outside the mandrel 16. In other words, to form the expansion space 17, the mandrel 16 narrows at its distal end.

FIG. 8 shows a product made with the apparatus of FIG. 7. In this product 11 the cells, i.e. the bubbles 18, have expanded in the direction of thickness into a needle-like form, because also in this case at the same time as the material of the intermediate layer 11e expanded, the surface layer 11c became cured so that it cannot yield in the longitudinal direction, thus preventing the material from expanding in the longitudinal direction.

Since the foamed material of the intermediated layer 11c has not been able to expand in the longitudinal direction, the product 11 has an extremely good compression strength and bending strength.

In some cases the characteristics disclosed in this application can be applied as such, irrespective of the other characteristics. On the other hand, the features disclosed here may be combined, when necessary, to provide different combinations.

The drawings and the associated specification are only meant to illustrate the idea of the invention. The details of the invention may vary within the scope of the claims. Hence instead of the conical extruder disclosed above, the invention may be implemented using single and/or twin screw extruders commonly known and used for extruding plastic, or some other known or a new extruder. It is important that the temperature of the mass to be processed is controlled in such a way that detrimental pre-cross-linking inside the apparatus does not occur excessively.

1-15. (canceled)

16. A method for making a composite product, the method comprising extruding a mixture of material with an extruder, the mixture containing fibre material and at least one plastic material, and
cross-linking the at least one plastic material in such a way that at least a surface of the wall of the product has a cross-linking degree that is higher than the cross-linking degree of an inner part of the wall of the product.

17. A method according to claim 16, wherein
the cross-linking is achieved by adding peroxide into the material to be extruded and by heating the surface of the material in an extruder by using heating means and friction heat.

18. A method according to claim 16, further comprising
forming at least a double-layered product in which the plastic material of the outer layer is cross-linked from the outer surface of the product.

19. A method according to claim 18, further comprising
forming an inner layer of the product from a mixture of a fibre material and polyvinyl acetate.

20. A composite product consisting of a fibre material and at least one plastic material, wherein
the plastic material of the product is cross-linked in such a way that at least a surface of the wall of the product has a cross-linking degree that is higher than the cross-linking degree of an inner part of the wall of the product.

21. A product according to claim 20, wherein
the cross-linked plastic material is made from polyethylene.

22. A product according to claim 20, wherein
the product has at least two layers, the plastic material of the outer layer being partly cross-linked and its inner layer is without cross-linking.

23. A product according to claim 22, wherein
the outer layer comprises a mixture of a cross-linked plastic material and fibre material, and the inner layer comprises a mixture of polyvinyl acetate and fibre material.

24. A product according to claim 20, wherein
the product has holes in which the cross-linking degree on the inner surface is higher than the cross-linking degree of the inner part of the product wall.

25. A product according to claim 20, wherein
the wall of the product is provided with an intermediate layer which is inside at least one surface layer, the average specific weight of the material of the surface layer being greater than the average specific weight of the material of the intermediate layer.

26. A product according to claim 25, wherein
the intermediate layer contains radial needle-like bubbles.

27. A product according to claim 25, wherein
the product is planar and has needle-like bubbles in the thickness direction thereof.

28. An extruder including a nozzle, means for feeding material through the nozzle, heating means for heating the material, cooling means arranged in connection with the nozzle to cool the material flowing through the nozzle so that a cooling zone is formed in the nozzle, and a mandrel arranged inside the nozzle, wherein
the mandrel is arranged to become smaller towards its distal end so that an expansion space is provided in the nozzle, the expansion space being arranged to start at the cooling zone or thereafter.

29. An extruder according to claim 28, wherein
the mandrel is provided with a centrally arranged conduit through which some of the material is able to flow, the expansion space being formed so that the conduit expands in the direction of flow of the material.

30. An extruder according to claim 28, wherein
the mandrel is arranged to the distal end of the inner stator of the extruder, the material being arranged to flow outside the mandrel and the expansion space being formed as the distal end of the mandrel becomes narrower.
